(19) United States
(12) Patent Application Publication
(10) Pub. No.: US 2009/0019712 A1
(43) Pub. Date: Jan. 22, 2009

(54) Apparatus and Method of Displaying Designs for a Building

(75) Inventor: J. Daniel Sinclair, Fort Myers, FL (US)

Correspondence Address: QUARLES & BRADY LLP, RENAISSANCE ONE, TWO NORTH CENTRAL AVENUE, PHOENIX, AZ, 85004-2391, US

(73) Assignee: SINCLAIR ABT, LLC, Fort Myers, FL (US)

(21) Appl. No.: 11/779,180

(22) Filed: Jul. 17, 2007

(51) Int. Cl. B43L 13/00

(52) U.S. Cl. 33/32.3

(57) ABSTRACT

A framework for moving a displayer over a foundation of a building to display the architectural features of the building onto the foundation. The framework contains a displayer that projects the images by either pigment or laser to increase the efficiency of constructing a building. The framework provides movement of the displayer in order to display the features on all portions of the foundation. The displayer may project the image on varying levels of the building by increasing the height of the framework. Movement of the displayer may be performed by various means and the displayer may move along the framework and the carrier for the displayer.

### FIELD OF THE INVENTION

The present invention relates in general to construction materials and, more particularly, to a design displayer for aiding in the construction of residential, commercial, and industrial buildings.

### BACKGROUND OF THE INVENTION

The construction of a building is a time-consuming process. While building techniques have improved and become more efficient, the process for constructing a building requires a substantial amount of time. The construction of a building includes the process of combining multiple dependent features with each other to form one complete building. The possibility of error is constant because of the assorted parts necessary to be assembled to create a building, and the errors cause substantial time delays.

Errors result from manufacturing error or human error. Manufacturing errors occur when components are not constructed according to the dimensions or specifications provided. Another major mistake is human error. An incorrect measurement of any component of the building causes major delays. Because the components are dependent on each other, a miscue in the measurement of one component will have an impact on the entire construction of the building.

Another problem is the considerable amount of time taken to make accurate measurements of every component in the building. Because of the intricate relationship between all of the parts of the building, an accurate measurement is required. If a measurement is not correct by even the smallest of margins, the resulting mistake can be large and costly. Further, the mistake causes an increase in time for correction. The workers may be forced to re-cut a new component or make changes to other parts to accommodate the mistake. Either method results in the waste of goods and workers' time.

Even accurate measurements of the component parts cause problems in construction. It takes time to make accurate measurements. Further, the measurements are taken more than once for the same components used in different areas of the building. This repetitive action requires time for the construction worker to verify the accuracy of the measurement. Though the measurement will be accurate, significant amount of time is required to achieve the accuracy.

Accurate measurements may still result in inaccurate cuts or fabrication of the component. The time committed to make the accurate measurement is wasted when the cut is executed incorrectly. The mistake requires a construction worker to repair the error. Time and money are wasted on the correction of the mistake, even one based on an accurate measurement.

The first step in constructing a building is the creation of the foundation. The rest of the components used to construct the building are placed on the foundation. Workers must place the components on the foundation in the correct location because of the interrelationship between all of the components to construct a building.

While some of the components are the same, like the walls, a measurement must be made for each component and cannot be replicated for subsequent components. Time and energy must be expended to measure and find the correct location for each component. The continual measurements cause delay in the construction of the building.

### SUMMARY OF THE INVENTION

In one embodiment, the present invention is a system for providing a design of a foundation of a building comprising a framework disposed around a portion of the foundation of the building, a carrier disposed across the foundation between opposite sides of the framework, the carrier being in moveable connection with the framework along a first direction parallel to the opposite sides of the framework, and a head disposed on the carrier, the head being in moveable connection with the carrier in a second direction orthogonal to the first direction and projecting architectural features of the building onto the foundation.

In another embodiment, the present invention is a system for displaying a design of a building comprising a carrier extending across a portion of a component of the building, and a display device for transmitting features of the design of the building onto a component of the building, the display device having a moveable connection with the carrier.

In another embodiment, the present invention is a method for providing a design of a foundation of a building comprising of providing a framework disposed around a portion of the foundation of the building, providing a carrier disposed across the foundation between opposite sides of the framework, the carrier being in moveable connection with the framework along a first direction parallel to the opposite sides of the framework; and providing a head disposed on the carrier, the head being in moveable connection with the carrier in a second direction orthogonal to the first direction and projecting architectural features of the building onto the foundation.

In another embodiment, the present invention is a building being constructed by the process of displaying a design of the building on a component of the building comprising the steps of providing a framework disposed around a portion of the foundation of the building, providing a carrier disposed across the foundation between opposite sides of the framework, the carrier being in moveable connection with the framework along a first direction parallel to the opposite sides of the framework, and providing a head disposed on the carrier, the head being in moveable connection with the carrier in a second direction orthogonal to the first direction and projecting architectural features of the building onto the foundation.

### BRIEF DESCRIPTION OF THE DRAWINGS

FIG. 1 illustrates a framework for displaying architectural features on a foundation of a building;

FIG. 2 illustrates a framework for displaying architectural features on a component of a building;

FIGS. 3A-3E illustrate various ways to provide movement of the displayer;

FIG. 4 illustrates a projector for displaying images onto a foundation of a building;

FIG. 5 illustrates a framework having wheels to move the displayer over the foundation of the building;

FIG. 6 illustrates a framework using a pulley system to move the displayer;

FIG. 7 illustrates a framework with sufficient height to display the image onto various levels of a building.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

The construction of a building can be made more efficient by the use of pre-manufactured pieces that are assembled on the job site. The pieces can be made in a controlled environment that will ensure the piece is constructed to the desired dimensions and materials that are desired by the builder. The location of the pre-manufactured components must be accurately determined to prevent errors from arising during the construction of the building. Measurements must be made to determine the correct location and placement of a component.

To construct a building with the design displayer as described herein, an architect or builder designs the layout of the building structure. The building may be a home, office, industrial, hotel, or commercial structure of any size and shape and as tall as the local building codes permit. The building designer creates a blueprint of the building. The designer selects the desired dimension of the building. Once the foundation for the building has been formed, additional components for the building may be placed on the foundation.

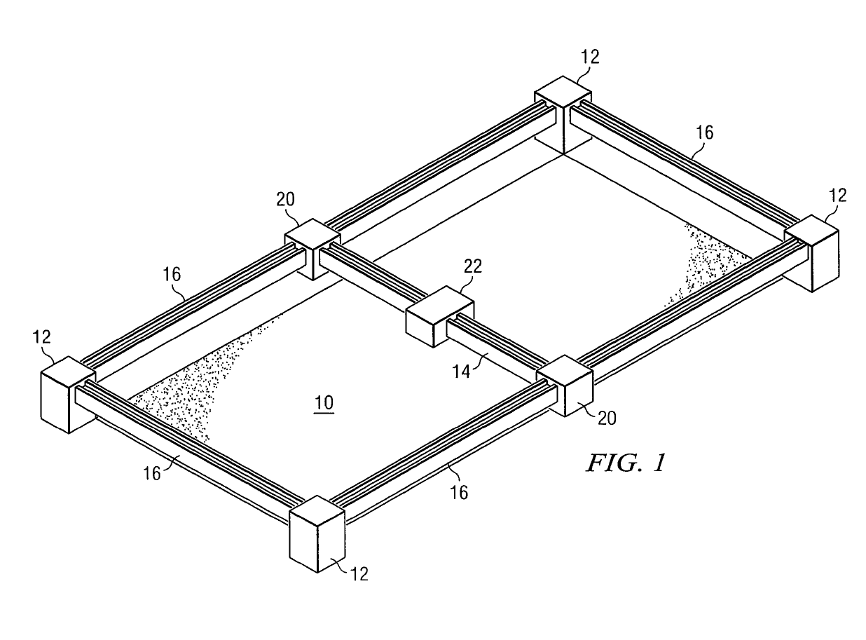

FIG. 1 illustrates the relationship of a foundation of a building and a displayer. The foundation may be for a residential, commercial, or industrial building. Foundation 10 may be formed in a variety of shapes depending on the chosen design for the building, such as square, rectangular, oval, circle, or some other shape. Foundation 10 may referred to as base of a building. FIG. 1 illustrates an overhead view of a system for displaying the design of a building onto foundation 10.

The system has plurality of footings 12. Footings 12 provide stability to the system as footings 12 are placed on top of the ground at the edges of foundation 10. Footings 12 may be placed on the edge of foundation 10 or over a portion of foundation 10. Depending on the design being displayed, footings 12 may be placed around the perimeter of the area where the design is to be displayed on foundation 10. Footings 12 may be of sufficient size and surface area to provide the necessary stability to the system. Because the system may expand over long lengths or be placed on uneven surfaces, footings 12 may need to have larger surface areas to absorb the stress. Increased size and area of footings 12 may be necessary if the ground is uneven or composed of such material that the increase is required for the system to be placed on the ground.

Footings 12 may include pads or springs that allow footings 12 to rest firmly on the ground or platform. Having a secured base for the system allows the system to stay in the correct location for displaying the design. Surfaces or platforms may consist of uneven or rough surfaces because the surface may be dirt or gravel.

Footings 12 must be placed in a position to allow the system to display the design on all portions of foundation 10. While displayer 22 may not display the entire design on all portions of foundation 10 at the same time, footings 12 must be located in a position that allows displayer 22 to display the design on part of foundation 10 at some time. Footings 12 may be located on the outside of foundation 10 to allow for displayer 22 to reach all areas of foundation 10. Displayer 22 may display the image at the edge or boundary of foundation 10, and footings 12 need to be in a location in relation to foundation 10 that permits displayer 22 to display the image or design.

Footings 12 may have absorbers or a suspension system to provide further stability to the system. As displayer 22 moves along the system, vibrations may occur that could shift the location of the system. Footings 12 may have absorbers or a suspension system to reduce or eliminate the vibrations and keep the system in the desired location. Movement of the system from the desired location could cause errors in the placement of components on foundation 10, which leads to an increase in time to construct the building.

Footings 12 are part of a framework or support structure that is disposed over a portion of foundation 10 of a building. The framework may contain a plurality of members 16. Members 16 may form a perimeter around a portion or all of foundation 10. The framework may include a system of four members. Members 16 may have varying lengths depending on the desired portion of foundation 10 that the framework is disposed across. Members 16 may have adjustable lengths to allow the members to be used at various job sites and on different shape foundations 10. The length of members 16 depends on the material used to construct members 16, such as metal, plastic, wood, or steel. The longer in length members 16 become the weight increases. One feature of the framework is the ability to move the framework to different job sites, and having members 16 of light weight facilitates moving members 16.

Members 16 are connected together to form a framework. Members 16 may be connected to footings 12 to provide stability to the framework. Members 16 may be welded, bonded, soldered, adhered, or attached to footings 12 to form the framework. Also, members 16 may be connected to footings 12 by clasps, pinion, nut and bolt system, or removable lock system to allow members 16 to be released from footings 12 and allow the framework to be disassembled. By disassembling members 16 from footings 12, the framework may be removed from each job site in an efficient manner. Members 16 may be connected to other members 16 by similar methods as discussed above.

Members 16 may have a track or path that allows carrier 14 to move along in a parallel direction across foundation 10. Members 16 may have a belt or rope system that provides movement to carrier 14. Having a system or ability to provide or assist in the movement of carrier 14, members 16 may allow the displayer 22 to project a design on foundation 10 over various portions of foundation 10 without having to move the framework. Members 16 may have a U-shape configuration allowing the movement mechanism of carrier 14 to move inside the U-shape of member 16. Members 16 may include a tube to allow carrier 14 to move along the tube.

Because foundation 10 may have various shapes, a plurality of members 16 may be used to provide sufficient disposition over foundation 10 to display the design on foundation 10. FIG. 1 illustrates a square shape for the framework with four members 16 connected to four footings 12. Members 16 may have curves or bends to provide various shapes to the framework, or members 16 may have expandable portions to allow member 16 to expand over various lengths. By having variable length, members 16 may be used on foundation 10 of various shapes and sizes. Members 16 may have a ratcheting system to adjust the length of members 16. In addition, members 16 may include collapsible portions to allow members 16 to be shortened or lengthened depending on the size of foundation 10 or the desired size of the framework.

Member 16 may be made of metal, plastic, or another hardenable material that can support the framework and the display system. Member 16 must be made of a material that can support carrier 14 as carrier 14 moves along members 16. Because the framework may be reused at other locations or job sites, members 16 may be made of a light weight material to allow for members 16 to be moved to different locations or job sites.

Carrier 14 may be disposed across members 16 that are opposite of each other. Carrier 14 may have a length to connect with members 16 in order for displayer 22 to project the design on all portions of foundation 10. By connecting with at least two members 16, carrier 14 can move along members 16 across a portion or the entire foundation 10. Carrier 14 may be adjustable in length to allow carrier 14 to be used at different job sites or locations. The adjustment in length can be accomplished by carrier 14 having a ratcheting system or a collapsible system. Foundation 10 may have various lengths, and carrier 14 may need to be lengthened or shortened to accommodate the various sizes and shapes of foundation 10.

Carrier 14 may include a triangulation connection with members 16. By having more connections with members 16, carrier 14 may have increased stability as carrier 14 moves over foundation 10. Also, carrier 14 may move in a rotational manner along members 16 and over foundation 10. Being connected to members 16 in a triangulation may allow carrier 14 to move easily in a rotational manner along the framework.

Carrier 14 may be connected to members 16 by a plurality of connectors 20. Each end of carrier 14 may have connector 20. Connectors 20 may provide movement of carrier 14 on members 16. Connectors 20 may include a motor, pulley system, treads, or track system to provide movement of carrier 14 along members 16. Connectors 20 may associate with the groove or track in members 16 to provide movement of carrier 14 along members 16. Carrier 14 must move over foundation 10 to allow displayer 22 to display the design onto foundation 10. With connectors 20 having the ability to provide movement to carrier 14, displayer 22 may display the design for the building over most or all of foundation 10.

Connector 20 may be connected to carrier 14 through means of welding, soldering, adhering, or a releasable locking mechanism. Carrier 14 may be connected to carrier 14 by a nut and bolt system, opening and pinion system. Carrier 14 must be connected to connectors 20 in a way that may withstand the pressure and weight of carrier 14. Further, connectors 20 must be connected to carrier 14 with enough strength to move carrier 14 along members 16. By having a releasable locking mechanism, carrier 14 can be removed from connectors 20 when carrier 14 is moved to a different job site or location.

Carrier 14 may have a track, conduit, path, or opening allowing displayer 22 to move along carrier 14. Displayer 22 may move along carrier 14 to project the design on foundation 10. Displayer 22 may not be able to project the entire design on foundation 10 at the same time, so being able to move along carrier 14 allows displayer 22 to project the design on foundation 10. Carrier 14 may have a belt or pulley system to move displayer 22 along carrier 14. The movement mechanism of carrier 14 may be attached or associated with connectors 20 allowing the moving parts to move in sync as carrier 14 moves over foundation 10.

Displayer 22 may have a plurality of heads for projecting the design on foundation 10. Displayer 22 may receive the information containing the design of the building to be displayed on foundation 10 by various methods including removable media, wireless communication with a computer, hard-wired to a computer, or displayer 22 may be moved by a person along carrier 14. Once displayer 22 has received the design, displayer 22 can project the design through a head located on displayer 22. The head may be located on the bottom of displayer 22, or on the sides of displayer 22 in such a manner to allow the design to be projected to foundation 10, which would be below displayer 22.

Displayer 22 may have a plurality of heads allowing displayer 22 to display various components of the building that are located in the same relative area at the same time or in some concurrent fashion. Displaying the design of various components at the same time allows displayer 22 to move efficiently along foundation 10 and take less time to display the entire design of the building onto foundation 10. Many components of a building are located near each other, and having a plurality of heads makes displayer 22 more effective at accurately displaying the image. Displayer 22 does not need to return to the location on foundation 10 when displayer 22 has a plurality of heads because displayer 22 would be able to display the design of various components at the same time.

Displayer 22 may be connected to connectors 20 in a manner that allows displayer 22 to direct or instruct connectors 20 to move along members 16 to place displayer 22 in the correct position to project the image onto foundation 10. The connection may be hard-wired, remote receiving mechanism, or a wireless communication mechanism to instruct connectors 20 to move at a desired time into the desired location. For displayer 22 to project the image at the correct location on foundation 10, displayer 22 may have to communicate with connectors 20 to provide movement of carrier 14 along members 16.

Displayer 22 may contain a nozzle for providing pigment or paint onto foundation 10. Displayer 22 may contain various pigments or paint to provide varying colors in order to display different architectural features of the building onto foundation 10. Because a building has multiple parts and components, displayer 22 may need various colors or a system of various indicia to specify the location of different parts of the building. Providing the location of various parts of the building increases the time and efficiency in constructing the building because workers are able to determine the exact location of all the components of the building.

Displayer 22 may contain a plurality of lasers for displaying the image or architectural features of the building. Displayer may include various mirrors or other mechanisms to provide a laser projection of various colors. Because a building may have multiple parts, displayer 22 may need various colors to indicate the location of different parts of the building. Within the plurality of lasers, each laser may project a different color to provide the location of various components of the building at the same time. Providing the location of various parts of the building increases the time and efficiency in constructing the building.

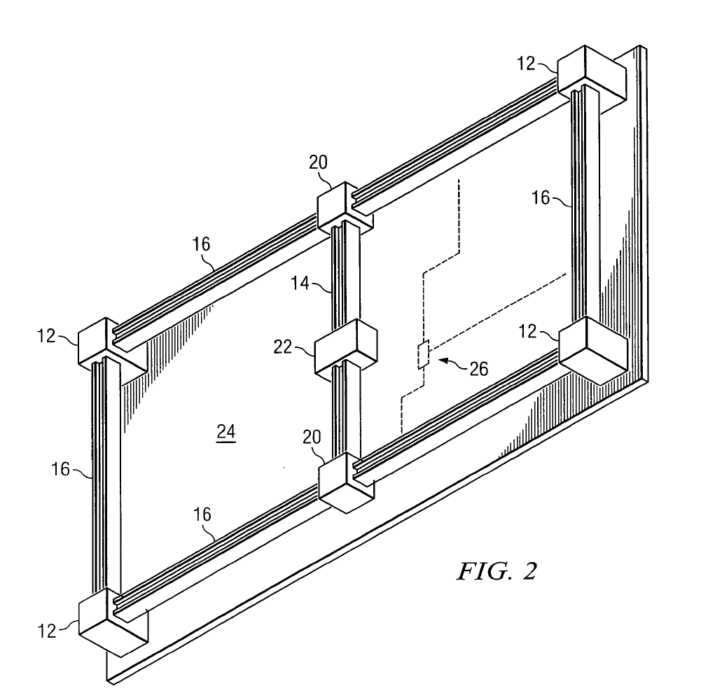

FIG. 2 illustrates a display system that may display the image or features of component 24 of the building. Displayer 22 may display or project the features of a component 24 on the component 24. By displaying the features on component 24, a worker may make the desired cuts or place objects at the desired location on component 24. Having the display on component 24 increases the time and efficiency of constructing the building. FIG. 2 illustrates a wall as component 24 with image of where to cut and place an electrical outlet and electrical wire in the wall. Displayer 22 may be used on other components 24 of the building to increase the time to construct the building by indicating the location of other components.

FIG. 2 illustrates component 24 laying down on a surface as the system is located above component 24. The system may be oriented in a manner to allow displayer 22 to display the image onto component 24 that is vertical in orientation. Some components 24 may be installed or be better situated for modifications and changes by being in a vertical orientation, or some orientation other than completely horizontal. The system can be oriented to allow displayer 22 to display the image onto a component 24 that must be or is already in a vertical orientation.

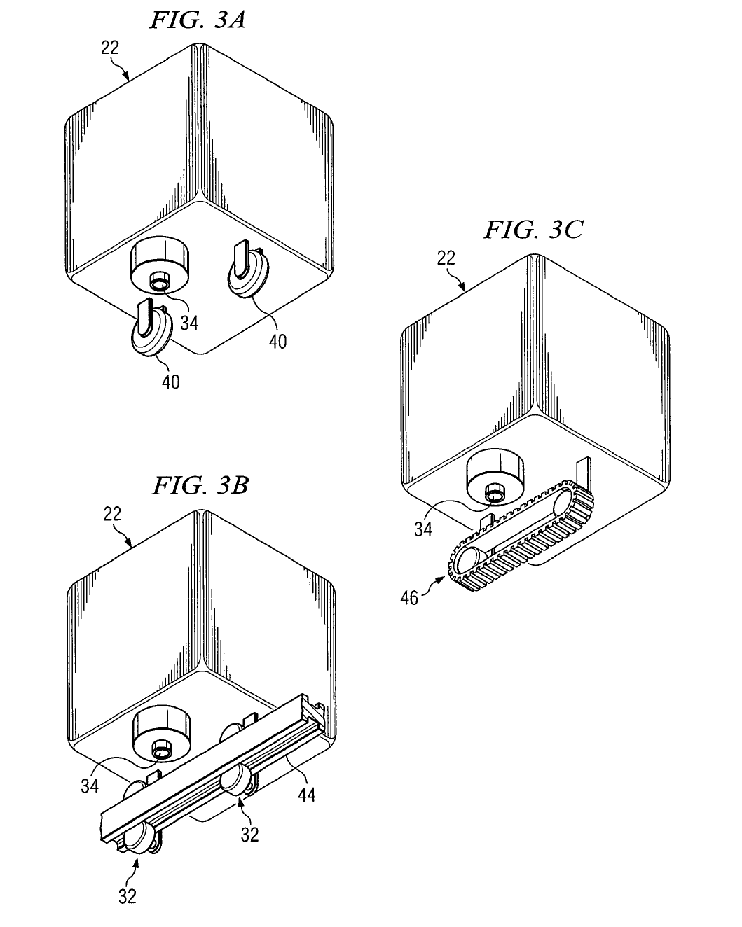

FIGS. 3A-3E illustrates various methods that displayer 22 may use to move along carrier 14. These methods of movement may be used with connectors 20 to move carrier 14 along members 16. Connectors 20 may move along by one of these methods of movement in the groove, path, or track way in members 16. FIG. 3A illustrates displayer 22 having a plurality of wheels 40 to provide movement along carrier 14. Wheels 40 allow displayer 22 to place head 34 in the correct location to display the architectural feature onto foundation 10. Displayer 22 may have a motor to move wheels 40 along carrier 14. Wheels 40 move displayer 22 along the track or path in carrier 14 to the correct location to display the image on foundation 10 or component 24.

FIG. 3B illustrates displayer 22 having a track holder 32 to provide movement along track 44 to provide movement along carrier 14. Track holder 32 allows displayer 22 to place head 34 in the correct location to display the architectural feature onto foundation 10. Displayer 22 may have a motor to move track holder 32 along carrier 14 by moving track 44 to the correct location to display the image on foundation 10 or component 24.

FIG. 3C illustrates displayer 22 having a tread mechanism 46 to provide movement along carrier 14. Tread mechanism 46 allows displayer 22 to place head 34 in the correct location to display the architectural feature onto foundation 10. Displayer 22 may have a motor to move tread mechanism 46 along carrier 14. Tread mechanism 46 moves displayer 22 along the track or path in carrier 14 to the correct location to display the image on foundation 10 or component 24.

FIG. 3D illustrates displayer 22 having a plurality of pulleys 48 to provide movement along carrier 14. Pulleys 48 allow displayer 22 to place head 34 in the correct location to display the architectural feature onto foundation 10. Displayer 22 may have a motor to move pulleys 48 along carrier 14. Pulleys 48 move displayer 22 along the track or path in carrier 14 to the correct location to display the image on foundation 10 or component 24.

FIG. 3E illustrates displayer 22 having a plurality of openings 50 to provide movement along carrier 14 by passing a belt, ribbon, or strap through openings 50. Openings 50 allow displayer 22 to place head 34 in the correct location to display the architectural feature onto foundation 10. Openings 50 move displayer 22 along the track or path in carrier 14 to the correct location to display the image on foundation 10 or component 24.

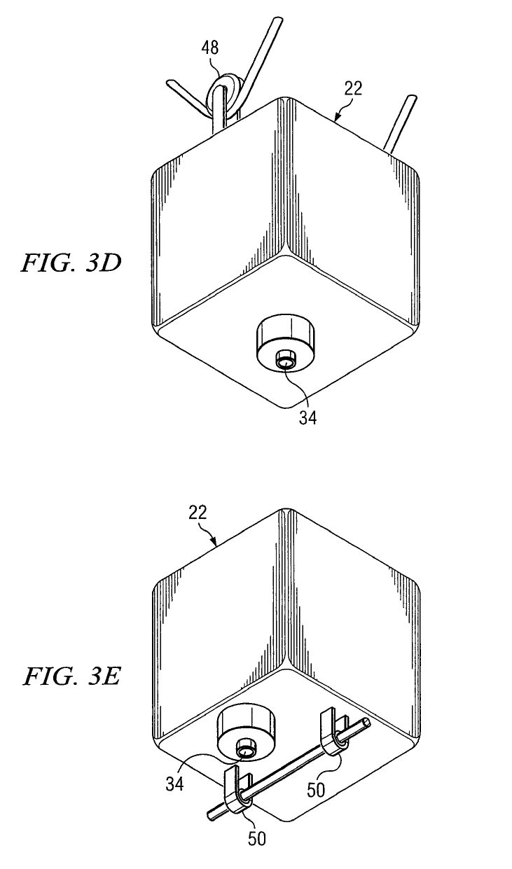

FIG. 4 illustrates projector 52 having a plurality of wheels 40 to provide movement of projector 52 over portions of foundation 10. Projector 52 may have a motor or moveable mechanism to position a plurality of heads 34 at the correct location to project the image onto foundation 10. Projector 52 may have a plurality of heads 34 to display the architectural features of the building onto multiple portions of foundation 10. Projector 52 may receive the information containing the design by various methods, removable media, wireless communication with a computer, hard-wired to a computer, or projector 52 may be moved by a person. Projector 52 may have a connection with the moveable mechanism to place projector 52 in the correct location once projector 52 has received the information about the design. Once projector 52 has received the input of the design, projector 52 may project the design through a plurality of heads 34 located on the bottom of projector 52 or through a plurality of heads 34 located on the sides of projector 52 or a combination of locations on projector 52.

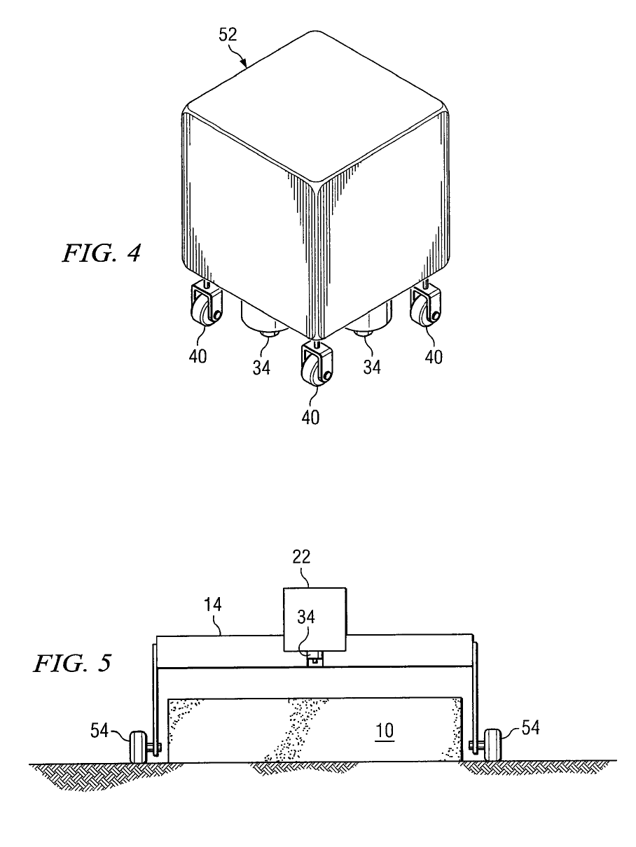

FIG. 5 illustrates displayer 22 connected to carrier 14 that spans a portion of foundation 10. Carrier 14 includes a plurality of rollers 54. Carrier 14 has length greater than foundation 10 or component 24 which allows rollers 54 to be placed on the ground. Rollers 54 may move carrier 14 along foundation 10. Rollers 54 may not be desired to be placed on foundation 10 because rollers 54 may impede the ability of displayer 22 to project the image. When displayer 22 utilizes pigment or paint, rollers 54 may smudge or damage the image on foundation 10 if rollers 54 are placed on foundation 10. By providing movement of carrier 14 on the ground, the images or display on foundation 10 are not disrupted or damaged. Displayer 22 may move along carrier 14 to display the architectural features on foundation 10 as rollers 54 move carrier 14 along foundation 10.

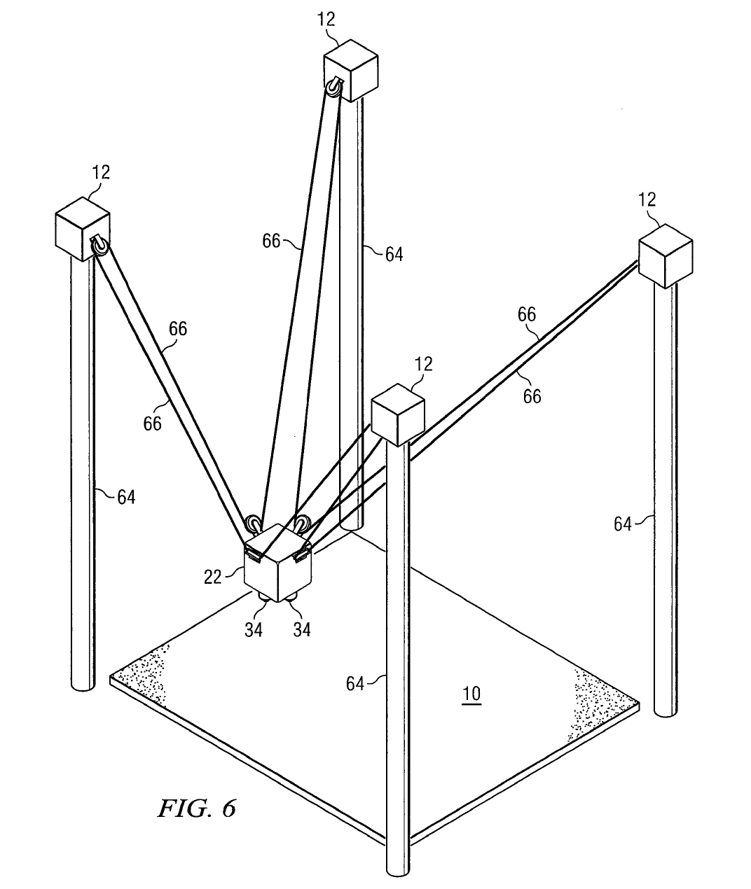

FIG. 6 illustrates displayer 22 being suspended above foundation 10 by a pulley system. Displayer 22 is suspended above a portion of foundation 10 by a plurality of cables 66. Cables 66 may include cables, ropes, string, twine, chain, or cord. Cables 66 may be connected to displayer 22 and footings 12 by a pulley system. Displayer 22 may provide movement by a motor that rotates the pulleys. Footings 12 may have a motor for rotating the pulleys to move displayer 22 into the correct position to display the image onto foundation 10.

Footings 12 may have extenders 64 that raise footings 12 above foundation 10. Foundation 10 may have various heights, and displayer 22 must be located above foundation 10 to display the image onto foundation 10. Further, footings 12 may need to have sufficient height to allow displayer 22 to project the architectural features onto foundation 10. Footings 12 may have an extended height by the use of a plurality of extenders 64.

Extenders 64 may be adjustable in height to allow the framework to be extended to the desired height for displayer 22 to project the image. Extenders 64 may have a ratchet system, may use air pressure system, crank system, or telescoping method to raise the framework to the desired height. The adjustability of extenders 64 allows the framework to be lowered when the job is complete. By lowering the framework by extenders 64, the framework can be transported to another job site.

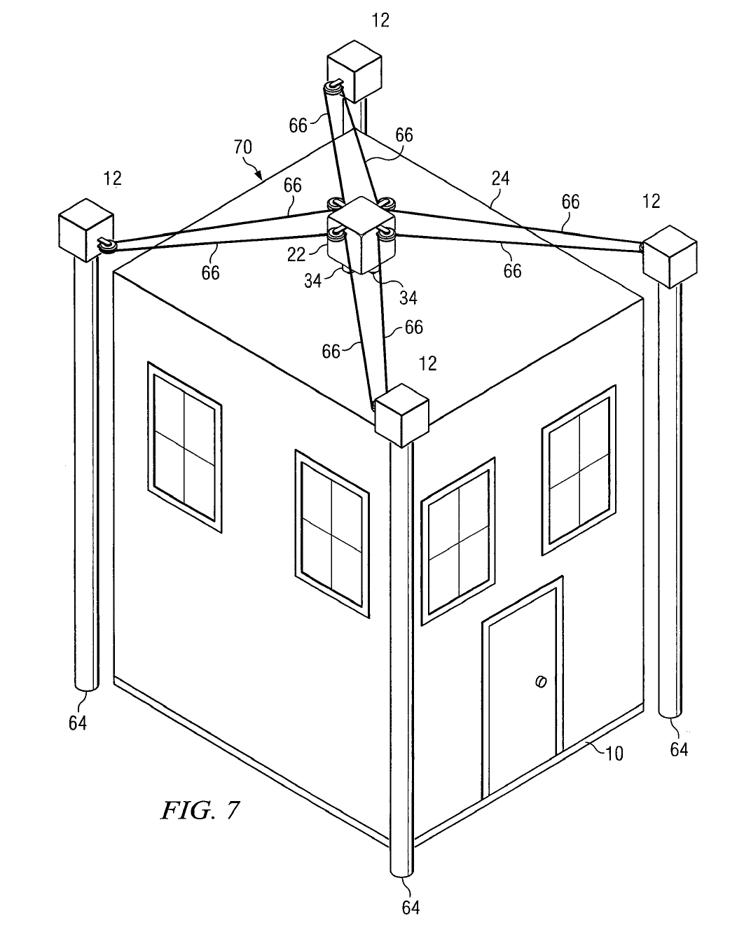

FIG. 7 illustrates the display system where displayer 22 projects the architectural features onto another floor of building 70. FIG. 7 illustrates displayer 22 displaying images onto a second floor of building 70. Building 70 may be constructed with a plurality of components 24, such as a wall or floor. Extenders 64 have a height to allow displayer 22 to display the image onto component 24. By displaying the image onto another floor, the time to construct building 70 may be decreased and be made more efficient because the location of all the necessary components is indicated at the precise location on the subsequent floor. Extenders 64 may have sufficient height to allow the framework to reach any floor of a building being constructed.

While one or more embodiments of the present invention have been illustrated in detail, the skilled artisan will appreciate that modifications and adaptations to those embodiments may be made without departing from the scope of the present invention as set forth in the following claims.

What is claimed is:

1. A system for providing a design of a foundation of a building, comprising:
a framework disposed around a portion of the foundation of the building;
a carrier disposed across the foundation between opposite sides of the framework, the carrier being in moveable connection with the framework along a first direction parallel to the opposite sides of the framework; and
a head disposed on the carrier, the head being in moveable connection with the carrier in a second direction orthogonal to the first direction and projecting architectural features of the building onto the foundation.

2. The system of claim 1, wherein the head includes a pulley system for providing movement of the head on the carrier.

3. The system of claim 1, wherein the head includes a motor for providing movement of the head on the carrier.

4. The system of claim 1, wherein the head includes a belt for providing movement of the head on the carrier.

5. The system of claim 1, wherein the head includes a nozzle for providing pigment for displaying the design.

6. The system of claim 1, wherein the head includes a laser for displaying the design.

7. A system for displaying a design of a building, comprising:
a carrier extending across a portion of a component of the building; and
a display device for transmitting features of the design of the building onto a component of the building, the display device having a moveable connection with the carrier.

8. The system of claim 7, wherein the carrier includes a support structure for surrounding the component of the building.

9. The system of claim 7, wherein the display device includes a pulley system for providing movement of the head on the carrier.

10. The system of claim 7, wherein the display device includes a motor for providing movement of the display device on the carrier.

11. The system of claim 7, wherein the display device includes a belt for providing movement of the display device on the carrier.

12. The system of claim 7, wherein the display device includes a nozzle for providing pigment onto the component of the building.

13. The system of claim 7, wherein the display device includes laser for displaying the design onto the component of the building.

14. A method for providing a design of a foundation of a building, comprising:
providing a framework disposed around a portion of the foundation of the building;
providing a carrier disposed across the foundation between opposite sides of the framework, the carrier being in moveable connection with the framework along a first direction parallel to the opposite sides of the framework; and
providing a head disposed on the carrier, the head being in moveable connection with the carrier in a second direction orthogonal to the first direction and projecting architectural features of the building onto the foundation.

15. The method of claim 14, wherein the head includes a pulley system for providing movement of the head on the carrier.

16. The method of claim 14, wherein the head includes a motor for providing movement of the head on the carrier.

17. The method of claim 14, wherein the head includes a belt for providing movement of the head on the carrier.

18. The method of claim 14, wherein the head includes a nozzle for providing pigment for displaying the design.

19. The method of claim 14, wherein the head includes a laser for displaying the design.

20. A building being constructed by the process of displaying a design of the building on a component of the building, comprising the steps of: providing a framework disposed around a portion of the foundation of the building;
providing a carrier disposed across the foundation between opposite sides of the framework, the carrier being in moveable connection with the framework along a first direction parallel to the opposite sides of the framework; and
providing a head disposed on the carrier, the head being in moveable connection with the carrier in a second direction orthogonal to the first direction and projecting architectural features of the building onto the foundation.

21. The process of claim 20, wherein the head includes a pulley system for providing movement of the head on the carrier.

22. The process of claim 20, wherein the head includes a motor for providing movement of the head on the carrier.

23. The process of claim 20, wherein the head includes a belt for providing movement of the head on the carrier.

24. The process of claim 20, wherein the head includes a nozzle for providing pigment for displaying the design.

25. The process of claim 20, wherein the head includes a laser for displaying the design.
